(19) United States
(12) Patent Application Publication
(10) Pub. No.: US 2021/0314992 A1
(43) Pub. Date: Oct. 7, 2021

(54) METHOD AND APPARATUS FOR SENDING UPLINK SCHEDULING REQUEST, DEVICE AND STORAGE MEDIUM

(71) Applicant: BEIJING XIAOMI MOBILE SOFTWARE CO., LTD., Beijing (CN)

(72) Inventor: Xiaowei JIANG, Beijing (CN)

(73) Assignee: BEIJING XIAOMI MOBILE SOFTWARE CO., LTD., Beijing (CN)

(21) Appl. No.: 17/267,006

(22) PCT Filed: Aug. 13, 2018
(86) PCT No.: PCT/CN2018/100299

§ 371 Date: Feb. 8, 2021

(51) Int. Cl. H04W 72/12; H04W 74/08

(52) U.S. Cl. CPC H04W 72/1284; H04W 74/0833

(57) ABSTRACT

Provided is a method for sending an uplink scheduling request (SR). The method includes determining whether a first uplink resource for sending the uplink SR is included in a first active bandwidth part (BWP) in response to sending the uplink SR. The first uplink resource is located on physical uplink control channel (PUCCH). The method further includes determining whether a second uplink resource for sending the uplink SR is included in each of n inactive BWPs in response to determining that no first uplink resource is included in the first active BWP. The second uplink resource is located on the PUCCH, and n is a positive integer. The method further includes sending the uplink SR to the base station over the second uplink resource in a first inactive BWP in response to determining that the second uplink resource is included in the first inactive BWP. The first inactive BWP is a BWP among the n inactive BWPs.

### CROSS-REFERENCE TO RELATED APPLICATION

This application is the U.S. national phase application of International Application No. PCT/CN2018/100299 filed on Aug. 13, 2018, the entire contents of which are incorporated herein by reference for all purposes.

### TECHNICAL FIELD

The present disclosure relates to the technical field of wireless communications, and in particular, relates to a method and an apparatus for sending an uplink scheduling request, and a device and a storage medium thereof.

### BACKGROUND

In a 5G new radio access technology (NR) communication system, a carrier may be divided into a plurality of bandwidth parts (BWP). For a user equipment (UE), only one active BWP is configured on a single carrier at any one time, and the UE may usually transmit data preferentially on this active BWP. Where uplink communication data that needs to be sent to a base station exists on a logical channel in the UE, the UE may send an uplink scheduling request (SR) to the base station over an active BWP in a serving cell, so as to request an uplink resource for transmitting the uplink communication data from the base station by using the uplink SR. However, in practical applications, it is likely that no physical uplink control channel (PUCCH) resource is included in the active BWP in the serving cell. At this time, the UE cannot send the uplink SR to the base station over the active BWP in the serving cell.

In the related art, where no PUCCH resource is included in the active BWP in the serving cell, the UE may send a random access request to the base station on an active BWP in a special cell for random access. If no physical random access channel (PRACH) resource is located in the active BWP in the special cell, the UE may instead send the random access request to the base station in an inactive BWP in the special cell for random access. In response to performing the random access, the UE can request the uplink resource for transmitting the uplink communication data from the base station.

### SUMMARY

The present disclosure provides a method and an apparatus for sending an uplink scheduling request SR, and a device and a storage medium thereof, which can improve the efficiency of a UE requesting an uplink resource from a base station.

According to a first aspect of the present disclosure, a method for sending an uplink SR is provided. The method includes determining whether a first uplink resource for sending the uplink SR is included in a first active BWP in response to sending the uplink SR. The first uplink resource is located on a PUCCH. Additionally, the method includes determining whether a second uplink resource for sending the uplink SR is included in each of n inactive BWPs in response to determining that no first uplink resource is included in the first active BWP. The second uplink resource is located on the PUCCH, and n is a positive integer. Furthermore, the method includes sending the uplink SR to the base station over the second uplink resource in a first inactive BWP in response to determining that the second uplink resource is included in the first inactive BWP, wherein the first inactive BWP is a BWP among the n inactive BWPs.

According to a second aspect of the present invention, a UE is provided. The UE includes a processor; and a memory configured to store at least one instruction executable by the processor. The processor is configured to determine whether a first uplink resource for sending an uplink SR is included in a first active BWP in response to sending the uplink SR. The first uplink resource is located on a PUCCH. The processor is further configured to determine whether a second uplink resource for sending the uplink SR is included in each of n inactive BWPs in response to determining that no first uplink resource is included in the first active BWP. The second uplink resource is located on the PUCCH, and n is a positive integer. The processor is further configured to send the uplink SR to the base station over the second uplink resource in a first inactive BWP in response to determining that the second uplink resource is included in the first inactive BWP, wherein the first inactive BWP is a BWP among the n inactive BWPs.

According to a third aspect of the present disclosure, a non-transitory computer-readable storage medium storing at least one computer program therein is provided. The at least one computer program, when run by a processor, causes the processor to perform acts according to the first aspect.

It should be understood that both the foregoing general description and the following detailed description are only exemplary and explanatory and are not restrictive of the present disclosure.

### BRIEF DESCRIPTION OF THE DRAWINGS

The accompanying drawings, which are incorporated in and constitute a part of this description, illustrate embodiments consistent with the present disclosure and, together with the description, serve to explain the principles of the present disclosure.

FIG. 1 is a schematic diagram of an implementation environment according to an exemplary embodiment;

FIG. 2 is a flowchart of a method for sending an uplink scheduling request according to an exemplary embodiment;

FIG. 3 is a flowchart of another method for sending an uplink scheduling request according to an exemplary embodiment;

FIG. 4 is a block diagram of an apparatus for sending an uplink scheduling request according to an exemplary embodiment;

FIG. 5 is a block diagram of another apparatus for sending an uplink scheduling request according to an exemplary embodiment; and

FIG. 6 is a block diagram of a device for sending an uplink scheduling request according to an exemplary embodiment.

### DETAILED DESCRIPTION

To make the objectives, technical solutions and advantages of the present disclosure clearer, the embodiments of the present disclosure are described in detail below with reference to the accompanying drawings.

Random access usually requires four interactions between the base station and the UE, which is time-consuming and has a risk of random access failure. Therefore, in the related art, the efficiency of the UE requesting the uplink resource from the base station is lower.

The technical solutions according to the embodiments of the present disclosure at least may achieve the following advantageous effects.

Whether the second uplink resource located on the PUCCH for transmitting the uplink SR is included in each of the n inactive BWPs is determined in response to determining that no first uplink resource located on the PUCCH for transmitting the uplink SR is included in the first active BWP, and the uplink SR is sent to the base station over the second uplink resource in response to determining that the second uplink resource is included in the first active BWP, wherein the first inactive BWP is a BWP among the n inactive BWPs. In the way, the UE is capable of attempting to send the uplink SR to the base station over the inactive BWP in a case where the UE cannot send the uplink SR to the base station over the first active BWP. Thus, a probability that the UE needs random access in a process of requesting of the uplink resource from the base station can be reduced to some extent, such that the efficiency of the UE requesting the uplink resource from the base station can be improved.

Exemplary embodiments are described in detail herein, examples of which are illustrated in the accompanying drawings. The following description refers to the accompanying drawings in which the same numbers in different drawings represent the same or similar elements unless otherwise indicated. The implementations set forth in the following description of exemplary embodiments do not represent all implementations consistent with the invention. Instead, they are merely examples of apparatuses and methods consistent with aspects related to the present disclosure as recited in the appended claims.

Where uplink communication data that needs to be sent to a base station exists in a logical channel in a user equipment (UE) in a wireless communication system, the UE can be triggered to send an uplink scheduling request (SR) to the base station. Under normal circumstances, the UE can send the uplink SR to the base station over a physical uplink control channel (PUCCH). In response to receiving the uplink SR sent by the UE, the base station may allocate an uplink resource for transmitting the uplink communication data to the UE based on the uplink SR and further interaction between the base station and the UE.

A carrier may be divided into a plurality of bandwidth parts (BWP) in a 5G new radio access technology (NR) communication system, and the UE can preferentially perform uplink transmission over an active BWP.

In the related art, in the process of sending of the uplink SR to the base station in the 5G NR communication system, the UE can determine whether a PUCCH resource is configured on the active BWP in a serving cell. If the PUCCH resource is configured, the UE can send the uplink SR to the base station over the PUCCH resource to request an uplink resource for sending uplink communication data from the base station. If no PUCCH resource is configured, the UE needs to perform random access to request the uplink resource for sending the uplink communication data from the base station in response to the random access.

Alternatively, while performing the random access, the UE can first determine whether a physical random access channel (PRACH) resource is configured on the active BWP in a special cell. If the PRACH resource is configured, the UE can send the random access request to the base station over the PRACH resource. If no PRACH resource is configured, the UE needs to continue to determine whether the PRACH resource is configured on the inactive BWP (for example, the initial BWP) in the special cell. If the PRACH resource is configured on the inactive BWP, the UE can send the random access request to the base station over the PRACH resource.

It can be seen from the above description that in the 5G NR communication system, in the process that the UE requests the uplink resource from the base station. That is, in the process that the UE sends the uplink SR to the base station, the probability that the UE needs the random access is higher. However, practice of the random access usually needs four interactions between the base station and the UE, which is time-consuming; and meanwhile, the random access has a risk of random access failure. Therefore, in the related art, the efficiency of the UE requesting the uplink resource from the base station is lower.

An embodiment of the present disclosure provides a method for sending an uplink SR, which can improve the efficiency of UE requesting an uplink resource from a base station.

In the method for sending the uplink SR, the UE can determine whether a second uplink resource located on a PUCCH for transmitting the uplink SR is included in each of n inactive BWPs in response to determining that no first uplink resource located on the PUCCH for transmitting the uplink SR is included in a first active BWP, and can send the uplink SR to the base station over the second uplink resource in response to determining that the second uplink resource is included in the first active BWP, wherein the first inactive BWP is a BWP among the n inactive BWPs. In the way, the UE is capable of attempting to send the uplink SR to the base station over the inactive BWP in a case where the UE cannot send the uplink SR to the base station over the first active BWP. Thus, a probability that the UE needs random access in a process of requesting of the uplink resource from the base station can be reduced to some extent, such that the efficiency of the UE requesting the uplink resource from the base station can be improved.

An implementation environment involved in the method for sending the RS according to the embodiments of the present disclosure is described below.

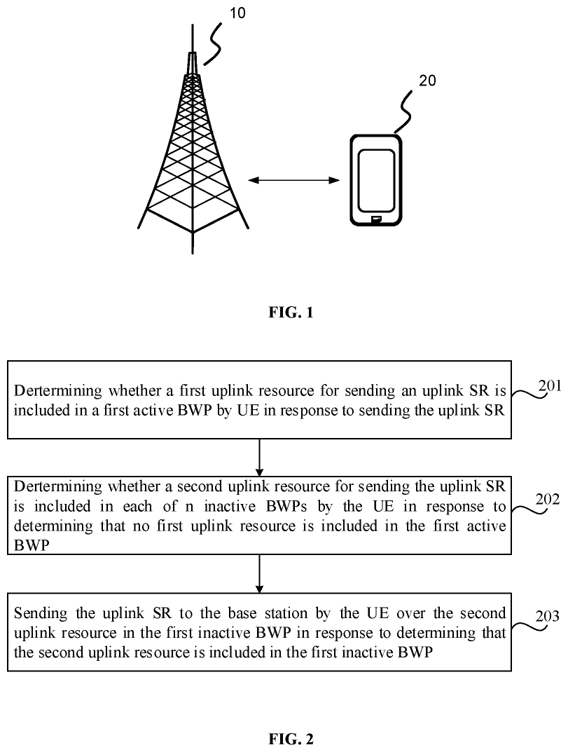

FIG. 1 is a schematic diagram of an implementation environment involved in a method for sending an uplink SR according to the embodiments of the present disclosure. As shown in FIG. 1, the implementation environment may include a base station 10 and a UE 20. The base station 10 and the UE 20 may be connected over a communication network, and the UE 20 is a UE in a cell served by the base station 10.

The above communication network may be a 5G NR communication network, or any of other communication networks similar to the 5G NR communication network.

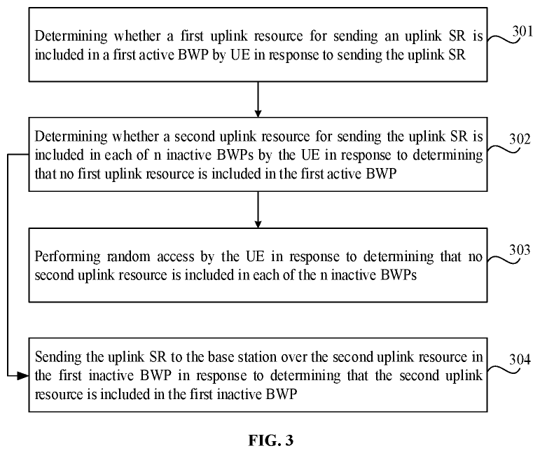

FIG. 2 is a flowchart of a method for sending an uplink SR according to an exemplary embodiment. The method may be applicable in the UE 20 shown in FIG. 1. As shown in FIG. 2, the method includes the following steps.

In 201, whether a first uplink resource for sending the uplink SR is included in a first active BWP is determined by the UE in response to sending the uplink SR.

The first uplink resource is located on a PUCCH.

In 202, whether a second uplink resource for sending the uplink SR is included in each of n inactive BWPs is determined by the UE in response to determining that no first uplink resource is included in the first active BWP.

The second uplink resource is located on the PUCCH, and n is a positive integer.

In 203, the uplink SR is sent to the base station by the UE over the second uplink resource in the first inactive BWP in response to determining that the second uplink resource is included in the first inactive BWP.

The first inactive BWP is a BWP in the n inactive BWPs.

In summary, in the method for sending the uplink SR, whether the second uplink resource located on the PUCCH for transmitting the uplink SR is included in each of the n inactive BWPs is determined in response to determining that no first uplink resource located on the PUCCH for transmitting the uplink SR is included in the first active BWP, and the uplink SR is sent to the base station over the second uplink resource in response to determining that the second uplink resource is included in the first active BWP, wherein the first inactive BWP is a BWP among the n inactive BWPs. In the way, the UE is capable of attempting to send the uplink SR to the base station over the inactive BWP in a case where the UE cannot send the uplink SR to the base station over the first active BWP. Thus, a probability that the UE needs random access in a process of requesting of the uplink resource from the base station can be reduced to some extent, such that the efficiency of the UE requesting the uplink resource from the base station can be improved.

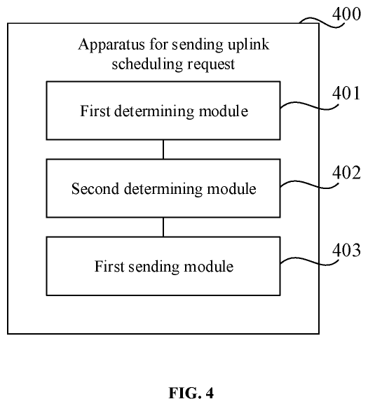

FIG. 3 is a flowchart of a method for sending an uplink SR according to an exemplary embodiment. The method may be applicable to the implementation environment shown in FIG. 1. As shown in FIG. 3, the method includes the following steps.

In 301, whether a first uplink resource for sending the uplink SR is included in a first active BWP is determined by the UE in response to sending the uplink SR.

The uplink SR may be triggered by the uplink communication data in a target logical channel of the UE. The first active BWP may be the active BWP in the serving cell or the active BWP in the special cell, and the first active BWP satisfied a logical channel prioritization (LCP) of the target logical channel. The first uplink resource is located on the PUCCH.

The LCP is an abbreviation of the logical channel prioritization.

Generally, different logical channels impose some requirements on uplink resources for transmitting the uplink communication data of the logical channels. These requirements can be characterized by the LCPs of the logical channels. For example, the LCP may include a requirement for spacing between sub-carriers of the uplink resource, a requirement on a physical uplink shared channel (PUSCH) of the uplink resource, or the like. Only the uplink resource satisfying the LCP of a logical channel can be used to transmit the uplink communication data of the logical channel. In step 301, the first active BWP for sending the uplink SR can satisfy the LCP of the target logical channel.

If the UE determines that the first uplink resource is included in the first active BWP, the UE can send the uplink SR to the base station over the first uplink resource. If the UE determines that no first uplink resource is included in the first active BWP, the UE can perform a technical process in 302.

In 302, whether a second uplink resource for sending the uplink SR is included in each of n inactive BWPs is determined by the UE in response to determining that no first uplink resource is included in the first active BWP.

The second uplink resource is located on the PUCCH; and n is a positive integer. The n inactive BWPs may all be inactive BWPs in the serving cell, or all inactive BWPs in the special cell, or may include both the inactive BWP in the serving cell and the inactive BWP in the special cell. In a case where n is equal to 1, the n inactive BWPs in 302 may be initial BWPs in the special cell, and may be located on an active carrier, wherein the active carrier satisfies the LCP of the target logical channel.

In the embodiment of the present disclosure, in response to determining that no first uplink resource is included in the first active BWP, the UE may not immediately perform random access, but instead determine whether the second uplink resource exists in the n inactive BWPs, so as to try to send the uplink SR to the base station over the inactive BWP. Thus, a probability that the UE needs the random access in a process of requesting of the uplink communication resource from the base station can be reduced, such that the efficiency of the UE requesting the uplink communication resource from the base station can be improved.

Alternatively, in the embodiment of the present disclosure, the UE can determine whether the second uplink resource is included in each of the n inactive BWPs one by one, and can stop determining whether the second uplink resource is included in the other inactive BWPs once it is determined that the second uplink resource is included in one inactive BWP.

In some embodiments, before determining whether the second uplink resource is included in each of the n inactive BWPs, the UE may also determine whether a third uplink resource for sending the uplink communication data is included in each of the n inactive BWPs, wherein the third uplink resource is configured to transmit the uplink communication data.

In response to determining that no third uplink resource exists in the n inactive BWPs, the UE may not need to request the uplink resource from the base station. That is, the UE may not need to send the uplink SR to the base station or perform random access, but can directly send the uplink communication data in the target logical channel to the base station over the third uplink resource in the n inactive BWPs. In this way, the UE can transmit the uplink communication data without performing the random access or sending the uplink SR to the base station. Therefore, before determining whether the second uplink resource is included in the inactive BWP, the UE may also determine whether the third uplink resource is included in the inactive BWP.

The UE can perform a technical process of determining whether the second uplink resource is included in the inactive BWP in response to determining that no third uplink resource is included in each of the n inactive BWPs.

In response to determining that the third uplink resource is included in one of the N inactive BWPs (hereinafter referred to as the third inactive BWP), and the third uplink resource in in the third inactive BWP satisfies the LCP of the target logical channel, the UE can send the uplink communication data in the target logical channel over the third uplink resource in the third inactive BWP, and can exit the process in response to sending the uplink communication data in the target logical channel over the third uplink resource in the third inactive BWP.

In response to determining that the third uplink resources are included in the inactive BWPs among the n inactive BWPs, but none of the third uplink resources satisfies the LCP of the target logical channel, the UE can perform the technical process of determining whether the second uplink resource is included in the inactive BWP.

Alternatively, in the same way as described above, in the embodiment of the present disclosure, the UE can determine whether the third uplink resource is included in each of the n inactive BWPs one by one. In response to determining that the third uplink resource is included in one BWP, and the third uplink resource satisfies the LCP of the target logical channel, the UE can stop determining whether the third uplink resource is included in the other inactive BWPs.

Alternatively, in the embodiment of the present disclosure, the UE can also determine whether the second uplink resource and the third uplink resource are included in each of the n inactive BWPs one by one, and can stop determining whether the second uplink resource or the third uplink resource is included in the other inactive BWPs once it is determined that the second uplink resource or the third uplink resource satisfies the LCP of the target logical channel is included in one inactive BWP.

The manner that the UE determines whether the second uplink resource, or the third uplink resource, or the second and third uplink resource exist(s) on each of the n inactive BWPs one by one can reduce the number of times that the UE needs to perform the determinations to some extent, such that the efficiency of the UE requesting the uplink resource from the base station can be improved.

In some embodiments, before determining whether the second uplink resource is included in each of the inactive BWPs, the UE may also determine whether a fourth uplink resource for sending a random access request is included in the second active BWP, wherein the fourth uplink resource is located on the PRACH.

In response to determining that the fourth uplink resource is included in the second active BWP, the UE can send the random access request to the base station over the fourth uplink resource, and exits the process.

The UE can perform the technical process of determining whether the second uplink resource is included in the inactive BWP in response to determining that no fourth uplink resource is included in the second active BWP.

The second active BWP is located in the special cell; or the second active BWP is located in the active serving cell.

In 303, the UE performs random access in response to determining that no second uplink resource is included in each of the n inactive BWPs.

The UE cannot send the uplink SR to the base station over the inactive BWP in response to determining that no second uplink resource is included in each of the n inactive BWPs. In this case, the UE can perform random access. That is, the UE can send the random access request to the base station.

If the UE has performed the technical process of determining whether the fourth uplink resource is included in the second active BWP before performing the technical process of determining whether the second uplink resource is included in each of the n inactive BWPs, the UE can determine whether a fifth uplink resource for sending the random access request is included in the n inactive BWPs while performing the random access in 303. The UE can send the random access request to the base station over the fifth uplink resource if the fifth uplink resource is included in the n inactive BWPs.

If the UE does not perform the technical process of determining whether the fourth uplink resource is included in the second active BWP before performing the technical process of determining whether the second uplink resource is included in each of the n inactive BWPs, the UE can determine whether the fourth uplink resource is included in the second active BWP while performing random access in 303. The UE can send the random access request to the base station over the fourth uplink resource in response to determining that the fourth uplink resource is included in the second active BWP. The UE can determine whether the fifth uplink resource is included in the n inactive BWPs in response to determining that no fourth uplink resource is included in the second active BWP. If the fifth uplink resource is included in the n inactive BWPs, the UE can send the random access request to the base station over the fifth uplink resource.

Alternatively, if the UE does not perform the technical process of determining whether a third uplink resource is included in each of the n inactive BWPs before performing the technical process of determining whether the second uplink resource is included in each of the n inactive BWPs, the UE can determine whether the third uplink resource is included in each of the n inactive BWPs before performing the random access.

In response to determining that no third uplink resource is included in each of the n inactive BWPs, or the third uplink resources are included in the inactive BWPs among the n inactive BWPs but none of the third uplink resources satisfies the LCP of the target logical channel, the UE can perform the random access.

In response to determining that the third uplink resource is included in the second inactive BWP and the third uplink resource in the second inactive BWP satisfies the LCP of the target logical channel, the UE can send the uplink communication data in the target logical channel to the base station over the third uplink resource in the second inactive BWP, and exits the process. The second inactive BWP is a BWP in the above n inactive BWPs.

In 304, the uplink SR is sent to the base station over the second uplink resource in the first inactive BWP in response to determining that the second uplink resource is included in the first inactive BWP.

The first inactive BWP is a BWP in the above n inactive BWPs.

In the embodiment of the present disclosure, there may be the second uplink resource in each of m inactive BWPs among the n inactive BWPs, wherein m is a positive integer less than n. The UE can select the first inactive BWP from the m inactive BWPs according to a predetermined selection sequence, and send the uplink SR to the base station over the second uplink resource in the first inactive BWP.

The predetermined selection sequence may be the sequence of priorities from high to low, the sequence of BWP identifiers from small to large, the sequence specified by a network side, etc., which are not specifically limited herein by the embodiment of the present disclosure. The priorities may be priorities configured on the network side.

In summary, in the method for sending the uplink SR, whether the second uplink resource located on the PUCCH for transmitting the uplink SR is included in each of the n inactive BWPs is determined in response to determining that no first uplink resource located on the PUCCH for transmitting the uplink SR is included in the first active BWP, and the uplink SR is sent to the base station over the second uplink resource in response to determining that the second uplink resource is included in the first active BWP, wherein the first inactive BWP is a BWP among the n inactive BWPs. In the way, the UE is capable of attempting to send the uplink SR to the base station over the inactive BWP in a case where the UE cannot send the uplink SR to the base station over the first active BWP. Thus, a probability that the UE needs random access in a process of requesting of the uplink resource from the base station can be reduced to some extent, such that the efficiency of the UE requesting the uplink resource from the base station can be improved.

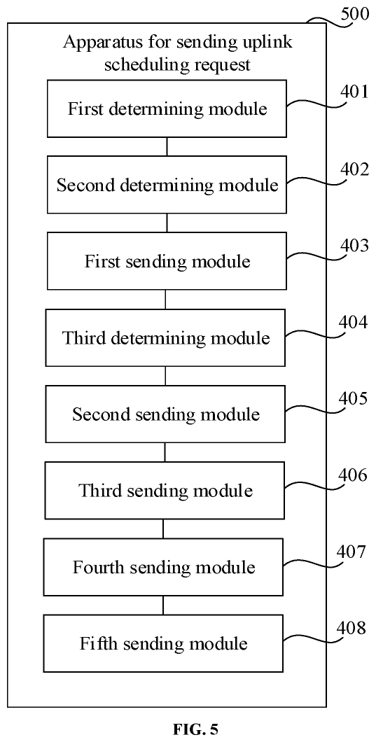

FIG. 4 is a block diagram of an apparatus 400 for sending an uplink SR according to an exemplary embodiment. The apparatus 400 may be applicable to the UE 20 shown in FIG. 1. Referring to FIG. 4, the apparatus 400 includes a first determining module 401, a second determining module 402, and a first sending module 403.

The first determining module 400 is configured to determine whether a first uplink resource for sending the uplink SR is included in a first active BWP in response to sending the uplink SR, wherein the first uplink resource is located on a PUCCH.

The second determining module 402 is configured to determine whether a second uplink resource for sending the uplink SR is included in each of n inactive BWPs in response to determining that no first uplink resource is included in the first active BWP, wherein the second uplink resource is located on the PUCCH, and n is a positive integer.

The first sending module 403 is configured to send the uplink SR to the base station over the second uplink resource in the first inactive BWP in response to determining that the second uplink resource is included in the first inactive BWP, wherein the first inactive BWP is a BWP among the n inactive BWPs.

In an embodiment of the present disclosure, the first sending module 403 is specifically configured to: select the first inactive BWP from the m inactive BWPs according to a predetermined selection sequence in response to determining that the second uplink resource is included in each of the m inactive BWPs among the n inactive BWPs, and send the uplink SR to the base station over the second uplink resource in the first inactive BWP.

In another embodiment of the present disclosure, the inactive BWP is an initial BWP in the special cell in a case where n is equal 1.

In another embodiment of the present disclosure, the inactive BWP is located on an active carrier, wherein the active carrier satisfies an LCP of a target logical channel, and the uplink communication data in the target logical channel triggers the uplink SR.

In another embodiment of the present disclosure, the first active BWP satisfies an LCP of a target logical channel, and the uplink SR is triggered by the uplink communication data in the target logical channel.

As shown in FIG. 5, in addition to the apparatus 400 for sending the uplink SR, an embodiment of the present disclosure further provides an apparatus 500 for sending an uplink SR. The apparatus 500 includes a third determining module 404, a second sending module 405, a third sending module 406, a fourth sending module 407, and a fifth sending module 408, in addition to all the modules in the apparatus 400.

The third determining module 404 is configured to determine whether a third uplink resource for sending uplink communication data is included in each of the n inactive BWPs in response to determining that no second uplink resource is included in each of the n inactive BWPs.

The third sending module 405 is configured to send the uplink communication data in a target logical channel over the third uplink resource in a third inactive BWP in response to determining that the third uplink resource is included in the third inactive BWP and the third uplink resource in the third inactive BWP satisfies an LCP of the target logical channel. The uplink communication data in the target logical channel triggers the uplink SR, and the second inactive BWP is a BWP among the n inactive BWPs.

In another embodiment of the present disclosure, the second determining module 402 is specifically configured to: determine whether a third uplink resource for sending uplink communication data is included in each of the n inactive BWPs in response to determining that no first uplink resource is included in the first active BWP, and determine whether the second uplink resource is included in each of the n inactive BWPs in response to determining that no third uplink resource is included in each of the n inactive BWPs.

The third sending module 406 is configured to send the uplink communication data in a target logical channel over the third uplink resource in a third inactive BWP in response to determining that the third uplink resource is included in the third inactive BWP and the third uplink resource in the third inactive BWP satisfies an LCP of the target logical channel, wherein the uplink communication data in the target logical channel triggers the uplink SR, and the second inactive BWP is a BWP among the n inactive BWPs.

The fourth sending module 407 is configured to send a random access request to the base station in response to determining that no second uplink resource is included in each of the n inactive BWPs.

The second determining module 402 is specifically configured to: determine whether a fourth uplink resource for sending a random access request is included in the second active BWP in response to determining that no first uplink resource is included in the first active BWP, wherein the fourth uplink resource is located on a physical random access channel (PRACH); and determine whether the second uplink resource is included in each of the n inactive BWPs in response to determining that no fourth uplink resource is included in the second active BWP.

The fifth sending module 408 is configured to send the random access request to the base station over the fourth uplink resource in response to determining that the fourth uplink resource is included in the second active BWP.

In another embodiment of the present disclosure, the second active BWP is located in a special cell; or the second active BWP is located in an active serving cell.

In summary, in the apparatus for sending the uplink SR, whether the second uplink resource located on the PUCCH for transmitting the uplink SR is included in each of the n inactive BWPs is determined in response to determining that no first uplink resource located on the PUCCH for transmitting the uplink SR is included in the first active BWP, and the uplink SR is sent to the base station over the second uplink resource in response to determining that the second uplink resource is included in the first active BWP, wherein the first inactive BWP is a BWP among the n inactive BWPs. In the way, the UE is capable of attempting to send the uplink SR to the base station over the inactive BWP in a case where the UE cannot send the uplink SR to the base station over the first active BWP. Thus, a probability that the UE needs random access in a process of requesting of the uplink resource from the base station can be reduced to some extent, such that the efficiency of the UE requesting the uplink resource from the base station can be improved.

With respect to the apparatus in the above embodiments, the specific manners for individual modules in the apparatus to perform operations have been described in detail in the embodiments of the related methods, and will not be elaborated herein.

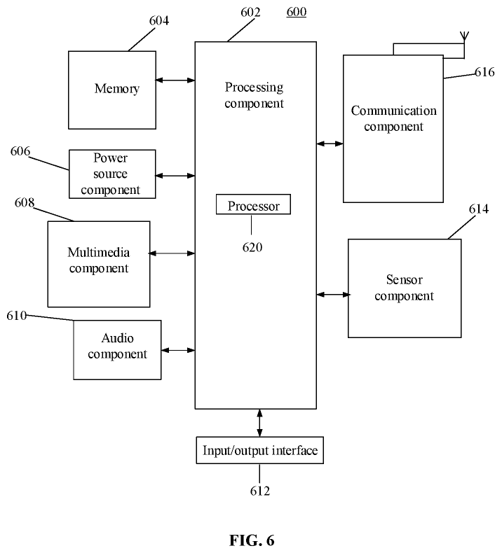

FIG. 6 is a block diagram of a device 600 for sending an uplink SR according to an exemplary embodiment. Fox example, the device 600 may be a mobile phone, a computer, a digital broadcast terminal, a message transceiver, a game console, tablet equipment, medical equipment, fitness equipment, a personal digital assistant or the like.

Referring to FIG. 6, the device 600 may include one or more following components: a processing component 602, a memory 604, a power source component 606, a multimedia component 608, an audio component 610, an input/output (I/O) interface 612, a sensor component 614, and a communication component 616.

The processing component 602 typically controls the overall operations of the apparatus 600, such as the operations associated with display, telephone calls, data communications, camera operations and recording operations. The processing component 602 may include one or more processors 620 to execute instructions to realize all or part of the steps in the above methods. Moreover, the processing component 602 may include one or more modules which facilitate the interaction between the processing component 602 and other components. For example, the processing component 602 may include a multimedia module to facilitate the interaction between the multimedia component 608 and the processing component 602.

The memory 604 is configured to store various types of data to support the operations of the device 600. Examples of such data include instructions for any applications or methods operated on the device 600, contact data, phonebook data, messages, pictures, video, etc. The memory 604 may be implemented by using any type of volatile or nonvolatile memory equipment, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power source component 606 provides power to various components of the device 600. The power source component 606 may include a power source management system, one or more power sources, and any other components associated with the generation, management, and distribution of power in the device 600.

The multimedia component 608 includes a screen providing an output interface between the device 600 and a user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes and gestures on the touch panel. The touch sensors may not only sense a boundary of a touch or swipe action, but also sense the time duration and a pressure associated with a touch or swipe action. In some embodiments, the multimedia component 608 includes a front camera and/or a rear camera. The front camera and/or the rear camera may receive external multimedia data while the device 600 is in an operation mode, such as a photographing mode or a video mode. Each of the front and rear cameras may be a fixed optical lens system or have a focus and optical zoom capability.

The audio component 610 is configured to output and/or input audio signals. For example, the audio component 610 includes a microphone (MIC) configured to receive external audio signals when the device 600 is in an operation mode, such as a call mode, a recording mode, and a voice recognition mode. The received audio signal may be further stored in the memory 604 or transmitted via the communication component 616. In some embodiments, the audio component 610 further includes a speaker used for outputting audio signals.

The I/O interface 612 provides an interface between the processing component 602 and peripheral interface modules, such as a keyboard, a click wheel, buttons, and the like. The buttons may include, but are not limited to, a home button, a volume button, a start button, and a lock button.

The sensor component 614 includes one or more sensors to provide status assessments of various aspects of the device 600. For instance, the sensor component 614 detects an ON/OFF status of the device 600, relative positioning of components, e.g., the display device and the mini-keypad, of the device 600, a change in position of the device 600 or a component of the device 600, a presence or absence of user's contact with the device 600, an orientation or an acceleration/deceleration of the apparatus 600, and a change in temperature of the device 600. The sensor component 614 may include a proximity sensor configured to detect the presence of nearby objects without any physical contact. The sensor component 614 may also include a light sensor, such as a CMOS or CCD image sensor, used for imaging applications. In some embodiments, the sensor component 614 may also include an accelerometer sensor, a gyroscope sensor, a magnetic sensor, a pressure sensor or a temperature sensor.

The communication component 616 is configured to facilitate wired or wireless communication between the device 600 and other equipment. The device 600 can access a wireless network based on a communication standard, such as WiFi, 2G, or 3G, or a combination thereof. In an exemplary embodiment, the communication component 616 receives a broadcast signal or broadcast associated information from an external broadcast management system via a broadcast channel. In another exemplary embodiment, the communication component 616 further includes a near-field communication (NFC) module to facilitate short-range communications. For example, the NFC module may be implemented based on the radio frequency identification (RFID) technology, infrared data association (IrDA) technology, ultra-wideband (UWB) technology, Bluetooth (BT) technology, and other technologies.

In another exemplary embodiment, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods.

Another exemplary embodiment of the present disclosure further provides a non-transitory computer-readable storage medium storing at least one instruction therein, such as a memory 604. The at least one instruction, when executed by a processor 620 in the device 600, causes the device 600 to perform the above method. For example, the non-transitory computer-readable storage medium may be a ROM, a random-access storage (RAM), a CD-ROM, a magnetic tape, a floppy disc, an optical data storage device, or the like.

Another exemplary embodiment of the present disclosure further provides a non-transitory computer-readable storage medium storing at least one instruction therein. The at least one instruction, when executed by a processor in a mobile terminal, causes the mobile terminal to perform the method for sending the uplink SR according to the embodiments of the present disclosure.

Another exemplary embodiment of the present disclosure further provides a computer-readable storage medium storing at least one computer program therein is further provided. The computer-readable storage medium is a nonvolatile computer-readable storage medium. The at least one computer program, when run by a processing component, causes the processing component to perform the method for sending the uplink SR according to the embodiments of the present disclosure.

An exemplary embodiment of the present disclosure further provides a computer program product storing at least one instruction therein. The at least one instruction, when executed by a computer, causes the computer to perform the method for sending the uplink SR according to the embodiments of the present disclosure.

An exemplary embodiment of the present disclosure further provides a chip. The chip includes a programmable logic circuit and/or a program instruction. The chip, when executed, is caused to perform the method for sending the uplink SR according to the embodiments of the present disclosure.

Other embodiments of the present disclosure are apparent to those skilled in the art from consideration of the description and practice of the present disclosure disclosed herein. The present disclosure is intended to cover any variations, uses, or adaptations of the present disclosure following the general principles thereof and including such departures from the present disclosure as come within known or customary practice in the art. The description and the embodiments are to be considered as exemplary only, and a true scope and spirit of the present disclosure is indicated by the following claims.

It is appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

1. A method for sending an uplink scheduling request (SR), comprising:
determining whether a first uplink resource for sending the uplink SR is included in a first active bandwidth part (BWP) in response to sending the uplink SR, wherein the first uplink resource is located on a physical uplink control channel (PUCCH);
determining whether a second uplink resource for sending the uplink SR is included in each of n inactive BWPs in response to determining that no first uplink resource is included in a first active BWP, wherein the second uplink resource is located on the PUCCH, and n is a positive integer; and
sending the uplink SR to the base station over the second uplink resource in the a first inactive BWP in response to determining that the second uplink resource is included in the first inactive BWP, wherein the first inactive BWP is a BWP among the n inactive BWPs.

2. The method according to claim 1, further comprising:
determining whether a third uplink resource for sending uplink communication data is included in each of the n inactive BWPs in response to determining that no second uplink resource is included in each of the n inactive BWPs; and
sending the uplink communication data in a target logical channel over the third uplink resource in a second inactive BWP in response to determining that the third uplink resource is included in the second inactive BWP and the third uplink resource in the second inactive BWP satisfies a logical channel prioritization (LCP) of the target logical channel, wherein
the uplink communication data in the target logical channel triggers the uplink SR, and the second inactive BWP is a BWP among the n inactive BWPs.

3. The method according to claim 1, wherein determining whether the second uplink resource for sending the uplink SR is included in each of the n inactive BWPs in response to determining that no first uplink resource is included in the first active BWP comprises:
determining whether a third uplink resource for sending uplink communication data is included in each of the n inactive BWPs in response to determining that no first uplink resource is included in the first active BWP; and
determining whether the second uplink resource is included in each of the n inactive BWPs in response to determining that no third uplink resource is included in each of the n inactive BWPs.

4. The method according to claim 3, further comprising:
sending the uplink communication data in a target logical channel over the third uplink resource in a third inactive BWP in response to determining that the third uplink resource is included in the third inactive BWP and the third uplink resource in the third inactive BWP satisfies logical channel prioritization (LCP) of the target logical channel, wherein
the uplink communication data in the target logical channel triggers the uplink SR, and the third inactive BWP is a BWP among the n inactive BWPs.

5. The method according to claim 1, wherein sending the uplink SR to the base station over the second uplink resource in the first inactive BWP in response to determining that the second uplink resource is included in the first inactive BWP comprises:
selecting the first inactive BWP from m inactive BWPs according to a predetermined selection sequence in response to determining that the second uplink resource is included in each of the m inactive BWPs among the n inactive BWPs, wherein m is a positive integer less than n; and
sending the uplink SR to the base station over the second uplink resource in the first inactive BWP.

6. The method according to claim 1, further comprising:
sending a random access request to the base station in response to determining that no second uplink resource is included in each of the n inactive BWPs.

7. The method according to claim 1, wherein determining whether the second uplink resource for sending the uplink SR is included in each of the n inactive BWPs in response to determining that no first uplink resource is included in the first active BWP comprises:
determining whether a fourth uplink resource for sending a random access request is included in a second active BWP in response to determining that no first uplink resource is included in the first active BWP, wherein the fourth uplink resource is located on a physical random access channel (PRACH); and
determining whether the second uplink resource is included in each of the n inactive BWPs in response to determining that no fourth uplink resource is included in the second active BWP.

8. The method according to claim 7, further comprising:
sending the random access request to the base station over the fourth uplink resource in response to determining that the fourth uplink resource is included in the second active BWP.

9. The method according to claim 7, wherein the second active BWP is located in a special cell.

10. The method according to claim 1, wherein n equals to 1 and there is one inactive BWP, and the inactive BWP is an initial BWP in a special cell.

11. The method according to claim 1, wherein the n inactive BWPs are located on an active carrier, wherein the active carrier satisfies a logical channel prioritization (LCP) of a target logical channel, and uplink communication data in the target logical channel triggers the uplink SR.

12. The method according to claim 1, wherein the first active BWP satisfies a logical channel prioritization (LCP) of a target logical channel, and uplink communication data in the target logical channel triggers the uplink SR.

13. (canceled)

14. A user equipment, comprising:
a processor; and
a memory, configured to store at least one instruction executable by the processor,
wherein the processor is configured to:
determine whether a first uplink resource for sending an uplink scheduling request (SR) is included in a first active bandwidth part (BWP) in response to sending the uplink SR, wherein the first uplink resource is located on a physical uplink control channel (PUCCH);
determine whether a second uplink resource for sending the uplink SR is included in each of n inactive BWPs in response to determining that no first uplink resource is included in the first active BWP, wherein the second uplink resource is located on the PUCCH, and n is a positive integer; and
send the uplink SR to the base station over the second uplink resource in a first inactive BWP in response to determining that the second uplink resource is included in the first inactive BWP, wherein the first inactive BWP is a BWP among the n inactive BWPs.

15. (canceled)

16. The method according to claim 7, wherein the second active BWP is located in an active serving cell.

17. The user equipment according to claim 14, wherein the processor is further configured to:
determine whether a third uplink resource for sending uplink communication data is included in each of the n inactive BWPs in response to determining that no second uplink resource is included in each of the n inactive BWPs; and
send the uplink communication data in a target logical channel over the third uplink resource in a second inactive BWP in response to determining that the third uplink resource is included in the second inactive BWP and the third uplink resource in the second inactive BWP satisfies a logical channel prioritization (LCP) of the target logical channel,
wherein the uplink communication data in the target logical channel triggers the uplink SR, and the second inactive BWP is a BWP among the n inactive BWPs.

18. The user equipment according to claim 14, wherein the processor is configured to determine whether the second uplink resource for sending the uplink SR is included in each of the n inactive BWPs in response to determining that no first uplink resource is included in the first active BWP comprises:
the processor is configured to:
determine whether a third uplink resource for sending uplink communication data is included in each of the n inactive BWPs in response to determining that no first uplink resource is included in the first active BWP; and
determining whether the second uplink resource is included in each of the n inactive BWPs in response to determining that no third uplink resource is included in each of the n inactive BWPs.

19. The user equipment according to claim 18, wherein the processor is further configured to:
send the uplink communication data in a target logical channel over the third uplink resource in a third inactive BWP in response to determining that the third uplink resource is included in the third inactive BWP and the third uplink resource in the third inactive BWP satisfies a logical channel prioritization (LCP) of the target logical channel, wherein the uplink communication data in the target logical channel triggers the uplink SR, and the third inactive BWP is a BWP among the n inactive BWPs.

20. The user equipment according to claim 14, wherein send the uplink SR to the base station over the second uplink resource in the first inactive BWP in response to determining that the second uplink resource is included in the first inactive BWP comprises:
select the first inactive BWP from m inactive BWPs according to a predetermined selection sequence in response to determining that the second uplink resource is included in each of the m inactive BWPs among the n inactive BWPs, wherein m is a positive integer less than n; and
send the uplink SR to the base station over the second uplink resource in the first inactive BWP.

21. The user equipment according to claim 14, wherein the processor is further configured to:
send a random access request to the base station in response to determining that no second uplink resource is included in each of the n inactive BWPs.

22. A non-transitory computer-readable storage medium storing at least one computer program therein, wherein the at least one computer program, when run by a processor, causes the processor to perform acts comprising:
determining whether a first uplink resource for sending the uplink (SR) is included in a first active bandwidth part (BWP) in response to sending the uplink SR, wherein the first uplink resource is located on a physical uplink control channel (PUCCH);
determining whether a second uplink resource for sending the uplink SR is included in each of n inactive BWPs in response to determining that no first uplink resource is included in the first active BWP, wherein the second uplink resource is located on the PUCCH, and n is a positive integer; and
sending the uplink SR to the base station over the second uplink resource in a first inactive BWP in response to determining that the second uplink resource is included in the first inactive BWP, wherein the first inactive BWP is a BWP among the n inactive BWPs.
